(19) United States
(12) Patent Application Publication
(10) Pub. No.: US 2024/0098860 A1
(43) Pub. Date: Mar. 21, 2024

(54) OPTOELECTRONIC COMPONENT, METHOD FOR CONTROLLING AT LEAST ONE SEGMENT OF AN OPTOELECTRONIC COMPONENT, AND METHOD FOR DETERMINING AN ARRANGEMENT OF AT LEAST TWO OPTOELECTRONIC COMPONENTS

(71) Applicant: ams-OSRAM International GmbH, Regensburg (DE)

(72) Inventors: Markus HOFMANN, Bad Abbach (DE); Alexander WILM, Regensburg (DE); Johannes HOECHTL, Hagelstadt (DE)

(21) Appl. No.: 18/038,656

(22) PCT Filed: Nov. 16, 2021
(86) PCT No.: PCT/EP2021/081862

§ 371 Date: May 24, 2023

(30) Foreign Application Priority Data
Nov. 26, 2020 (DE) 102020131346.2

(51) Int. Cl. H05B 47/105

(52) U.S. Cl. CPC H05B 47/105

(57) ABSTRACT

An optoelectronic component is specified, comprising at least one segment, wherein each segment comprises a radiation-emitting semiconductor chip configured to emit electromagnetic radiation into a region, and each segment is assigned a radiation-detecting semiconductor chip configured to detect electromagnetic radiation from the region. Furthermore, a method for controlling at least one segment of the optoelectronic component and a method for determining an arrangement of at least two optoelectronic components are specified.

An optoelectronic component is specified. Furthermore, a method for driving at least one segment of an optoelectronic component and a method for determining an arrangement of at least two optoelectronic components are specified.

An object to be solved is to specify an optoelectronic component which is particularly functional. Furthermore, a method for driving at least one segment of the optoelectronic component and a method for determining an arrangement of at least two such optoelectronic components are to be specified.

For example, the optoelectronic component has a main extension plane. A vertical direction extends perpendicular to the main extension plane and lateral directions extend parallel to the main extension plane.

According to at least one embodiment, the optoelectronic component comprises at least one segment. For example, the optoelectronic component comprises exactly one segment. Alternatively, the optoelectronic component comprises, for example, two or more segments.

Each segment extends, for example, in lateral directions. For example, the segments are arranged next to each other in lateral directions. Directly adjacent segments are in direct contact with each other, for example.

For example, the optoelectronic component comprises more than two segments. For example, the segments do not overlap in lateral direction. For example, the segments are arranged at grid points of a first regular grid. In this case, the segments are arranged in a matrix-like manner, i.e. along rows and columns. The first regular grid can be, for example, a triangular grid, a quadrangular grid, or a hexagonal grid.

For example, the optoelectronic component comprises nine segments. In this case, the segments are arranged in a matrix-like manner along three rows and three columns, for example. Each column and each row comprises three segments, for example.

According to at least one embodiment of the optoelectronic component, each segment comprises a radiation emitting semiconductor chip configured to emit electromagnetic radiation into a region. The radiation emitting semiconductor chip is, for example, a light-emitting diode chip or a laser diode chip. For example, the radiation emitting semiconductor chip is configured to emit electromagnetic radiation from a radiation emitting surface during operation. The electromagnetic radiation emitted from the radiation emitting semiconductor chip can be ultraviolet radiation, near-ultraviolet radiation, visible light, near-infrared radiation, and/or infrared radiation.

For example, the radiation emitting semiconductor chip is configured to illuminate the region. For example, a main surface of the radiation emitting semiconductor chip extends in lateral directions. The region is arranged below the radiation emitting semiconductor chip in vertical directions.

For example, each segment comprises more than one radiation emitting semiconductor chip. In this case, the radiation emitting semiconductor chips are arranged adjacent to each other in lateral directions. For example, the radiation emitting semiconductor chips do not overlap in lateral directions. For example, the radiation emitting semiconductor chips are arranged at grid points of a second regular grid. In this case, the radiation emitting semiconductor chips are arranged in a matrix-like manner, that is, along rows and columns. The second regular grid can be, for example, a triangular grid, a quadrangular grid, or a hexagonal grid.

For example, all radiation emitting semiconductor chips of a segment are drivable together. Alternatively, it is possible that each individual radiation emitting semiconductor chip of a segment is drivable independently of the other radiation emitting semiconductor chips of the segment. When the individual radiation emitting semiconductor chips are driven independently, each radiation emitting semiconductor chip forms a sub-segment of a segment.

According to at least one embodiment of the optoelectronic component, each segment includes a radiation detecting semiconductor chip configured to detect electromagnetic radiation from the region. For example, each segment comprises a radiation detecting semiconductor chip configured to detect electromagnetic radiation from the region. The radiation detecting semiconductor chip is, for example, a photodetector such as a photodiode.

If the optoelectronic component comprises at least two segments, each segment comprises, for example, a single radiation detecting semiconductor chip.

If the optoelectronic component comprises exactly one segment, the segment comprises, for example, a segmented radiation detecting semiconductor chip. The segmented radiation detecting semiconductor chip is, for example, a field sensor module. In particular, the field sensor module comprises at least two fields, each formed with a radiation detecting semiconductor chip.

Advantageously, such a segmented radiation detecting semiconductor chip can be retrofitted into an already existing optoelectronic component comprising at least one radiation emitting illuminant. For example, the illuminant is at least one radiation emitting semiconductor chip. In this case, the segmented radiation detecting semiconductor chip can be spatially separated from the illuminant. The segmented radiation detecting semiconductor chip can further provide spatial resolution.

For example, the radiation detecting semiconductor chip is configured to detect electromagnetic radiation emitted by the region during operation. In this case, the regions do not actively emit the electromagnetic radiation. The radiation emitted by the radiation emitting semiconductor chip is reflected, for example, in the region. The radiation emitted from the region and received by the radiation detecting semiconductor chip is the radiation reflected in the region. In addition, the radiation detecting semiconductor chip can be configured to detect ambient light surrounding the optoelectronic component.

The electromagnetic radiation enters the radiation detecting semiconductor chip through a radiation entrance surface. The electromagnetic radiation detected by the radiation detecting semiconductor chip can be near-ultraviolet radiation, visible light, and/or near-infrared radiation.

In at least one embodiment, the optoelectronic component comprises at least one segment, wherein each segment comprises a radiation emitting semiconductor chip configured to emit electromagnetic radiation into a region. Further, a radiation detecting semiconductor chip is assigned to each segment, which is configured to detect electromagnetic radiation from the region.

One idea is, among other things, that such an optoelectronic component comprises a radiation emitting semiconductor chip and radiation detecting semiconductor chip. Thus, an illumination of the region by the segments can be checked and adjusted advantageously at any time.

According to at least one embodiment of the optoelectronic component, at least one segment comprises a common carrier on which the radiation emitting semiconductor chip and the radiation detecting semiconductor chip are arranged. For example, each segment comprises a common carrier. For example, the radiation emitting semiconductor chip and the radiation detecting semiconductor chip are electrically conductively connected to the common carrier.

The common carrier is formed with or consists of, for example, a metallic and/or ceramic material. The carrier is or comprises, for example, a circuit board, a printed circuit board (PCB) or a lead frame.

According to at least one embodiment of the optoelectronic component, at least one segment comprises an optics. For example, lateral dimensions of a region are predetermined dependent on the optics arranged over the radiation emitting semiconductor chip of the segment. For example, each segment comprises an optics.

The optics is for example a lens, which is configured for collimation or focusing of electromagnetic radiation. The lens can be formed spherical, aspherical or as a freeform. Furthermore, the lens is configured, for example, as cylindrical lens, semi-cylindrical lens, plano-convex lens, bi-convex lens or Fresnel lens. The optics comprises or consists of, for example, a plastic, a glass, or sapphire.

According to at least one embodiment of the optoelectronic component, the optics is arranged on the radiation emitting semiconductor chip and the radiation detecting semiconductor chip of a segment. In this embodiment, the optics is a common optics for the radiation emitting semiconductor chip and the radiation detecting semiconductor chip. For example, the optics completely overlap with the radiation emitting semiconductor chip and the radiation detecting semiconductor chip in the lateral direction.

According to at least one embodiment of the optoelectronic component, the optics is arranged on the radiation emitting semiconductor chip of a segment. For example, the optics overlap exclusively with the radiation emitting semiconductor chip in lateral directions. In this embodiment, the radiation detecting semiconductor chip is formed without overlapping with the optics. In this embodiment, no optics is arranged on the radiation detecting semiconductor chip.

According to at least one embodiment of the optoelectronic component, at least one segment comprises at least two optics.

According to at least one embodiment of the optoelectronic component, one of the two optics is arranged on the radiation detecting semiconductor chip of a segment. The one of the two optics overlaps, for example, in lateral directions with the radiation emitting semiconductor chip. In this embodiment, the radiation detecting semiconductor chip is formed without overlapping with the one of the two optics.

According to at least one embodiment of the optoelectronic component, the other of the two optics is arranged on the radiation emitting semiconductor chip of a segment. The other of the two optics overlaps exclusively with the radiation detecting semiconductor chip in lateral directions, for example. In this embodiment, the radiation emitting semiconductor chip is formed without overlapping with the other of the two optics.

Thus, the optics can be particularly well adapted to properties and/or requirements of the radiation emitting semiconductor chip and/or the radiation detecting semiconductor chip.

According to at least one embodiment of the optoelectronic component, the optoelectronic component comprises an electronic semiconductor chip that is electrically conductively connected to at least one segment. For example, the electronic semiconductor chip is electrically conductively connected to the radiation detecting semiconductor chip and the radiation emitting semiconductor chip, respectively.

The electronic semiconductor chip is formed with or has an integrated circuit (IC), for example. The integrated circuit comprises, for example, a control unit, an evaluation unit and/or a drive unit.

The control unit and the evaluation unit are configured, for example, to read out and check a measured value of the radiation emitting semiconductor chip. The measured value is, for example, a luminance in the region. For example, the electronic semiconductor chip is configured to read out each radiation emitting semiconductor chip individually. That is, the radiation detecting semiconductor chips of different segments can be read out independently of each other by the electronic semiconductor chip, for example.

The drive unit is configured, for example, to drive the radiation emitting semiconductor chip of a segment. The radiation emitting semiconductor chips of different segments can be controlled independently of each other by the electronic semiconductor chip, for example. For example, an operating current of the radiation emitting semiconductor chips can be predetermined by the control.

A method for driving at least one segment of the optoelectronic component having at least two segments is further disclosed. All features and embodiments disclosed in connection with the optoelectronic component are therefore also disclosed in connection with the method, and vice versa.

According to at least one embodiment of the method, an optical signal is generated in the region with a mobile device. The mobile device is configured to emit electromagnetic radiation, for example. The mobile device is, for example, a mobile phone with a radiation-generating unit, such as a flash light. The electromagnetic radiation emitted by the mobile device is, for example, an ultraviolet radiation, visible light, in particular white light, and/or near-infrared radiation.

For example, the optical signal is formed with the electromagnetic radiation generated by the mobile device. The optical signal comprises, for example, a predetermined sequence formed with the electromagnetic radiation. For example, the sequence is formed with a plurality of pulses of the electromagnetic radiation staggered in time. That is, the optical signal comprises a predetermined sequence of the generated electromagnetic radiation.

According to at least one embodiment of the method, the optical signal from the mobile device is received by the radiation detecting semiconductor chip associated with the region. The received optical signal can subsequently be evaluated by the electronic semiconductor chip.

According to at least one embodiment of the method, one of the segments associated with the radiation detecting semiconductor chip is driven dependent on the optical signal of the mobile device. The segment, in particular the radiation emitting semiconductor chip of the segment associated with the radiation detecting semiconductor chip, can subsequently be driven by means of the electronic semiconductor chip dependent on the evaluation of the optical signal.

Furthermore, it is conceivable that the radiation detecting semiconductor chip also receives a gesture from a person in the region in addition to the optical signal from the mobile device. The person is, for example, a user of the mobile device. In this case, one of the segments assigned to the radiation detecting semiconductor chip is driven depending on the optical signal of the mobile device and the gesture.

Advantageously, segments can be driven particularly easily by such a method. Advantageously, the segments do not have to communicate directly with each other, since the individual segments configured to illuminate specific regions are driven dependent on the optical signal from the mobile device. This means that individual regions can be illuminated particularly easily dependent on the optical signal. That is, an illumination of individual predetermined regions can be increased particularly easily. Furthermore, the illumination of individual predetermined regions can be reduced particularly easily.

The component can be controlled and configured to individual needs by the optical signal of the mobile device with advantage completely without a central control system. Thus, an illumination of a specific desk within a room of, for example, 500 lx can be generated particularly easily. Further energy savings can be achieved by reducing the illumination of non-relevant areas.

Furthermore, a color point and/or a color temperature in a specific region to be illuminated can be predetermined dependent on the optical signal. This means that a spectral composition of the region to be illuminated can be predetermined dependent on the optical signal. Thus, among other things, melanopic activation by cyan light can also be achieved in the region.

According to at least one embodiment of the method, at least two regions are formed without overlapping in lateral directions.

Each radiation emitting semiconductor chip is configured to illuminate a region, in particular a single region. The region that is illuminated by a single semiconductor chip has, for example, a luminance. The luminance of the region determines the surface brightness with which an eye of an observer perceives the region. For example, the region has a maximum in luminance at a central position of the region. Furthermore, the luminance decreases, for example, in the direction of a boundary of the region. For example, a luminance at a boundary of the region is at least 50% less than the luminance at the central position of the region.

In this embodiment, the radiation emitting semiconductor chips of the at least two segments are each configured to illuminate a region, wherein the regions are configured to be non-overlapping. That is, each segment is configured to illuminate a region, wherein the illuminated regions do not overlap with each other.

According to at least one embodiment of the method, the optoelectronic component comprises at least three segments.

According to at least one embodiment of the method, at least two of the regions are formed overlapping in lateral directions. In this case, the radiation emitting semiconductor chips of two segments emit electromagnetic radiation into one region each, wherein these regions overlapping with each other in lateral directions. For example, the regions overlap in lateral directions by at least 5%, in particular by at least 20%. Furthermore, it is possible that the at least two regions overlap completely with each other.

According to at least one embodiment of the method, the segment is driven dependent on the optical signal from the mobile device such that a luminance in the region is increased or such that a luminance in the region is decreased.

For example, the operating current of the radiation emitting semiconductor chip is predetermined dependent on the optical signal. For example, the operating current can be increased or decreased depending on the optical signal. When the operating current of the radiation emitting semiconductor chip is increased, the luminance with which the region of the radiation emitting semiconductor chip is illuminated is also increased, and vice versa.

According to at least one embodiment of the method, at least two segments of different optoelectronic components have two regions, which are formed overlapping in lateral directions.

According to at least one embodiment of the method, the segments of the different optoelectronic components are driven dependent on the optical signal. In this embodiment, the regions of at least two segments of different optoelectronic components overlap. Thus, it is possible, for example, that two segments of different optoelectronic components are driven in such a way that an illumination in a common region is predetermined dependent on the optical signal. The common region is formed here with the overlapping regions.

In addition, a method for determining an arrangement of at least two optoelectronic components is specified. All features and embodiments disclosed in connection with the optoelectronic component are therefore also disclosed in connection with the method, and vice versa.

According to at least one embodiment of the method, an optical signal is generated with segments from at least one of the optoelectronic components. For example, the optical signal is generated with all segments from the optoelectronic component. For example, the optical signal is formed with electromagnetic radiation generated by the segments of the optoelectronic component. For example, the optical signal includes the predetermined sequence formed with the electromagnetic radiation.

According to at least one embodiment of the method, the optical signal is received from one of the segments of another optoelectronic component. For example, the optical signal is received from at least one of the segments, in particular from at least one of the radiation detecting semiconductor chips, of the other optoelectronic component.

According to at least one embodiment of the method, an arrangement of the at least two optoelectronic components is determined dependent on the received optical signal. The arrangement indicates, for example, a spatial arrangement of the optoelectronic components in lateral directions. The determination of the arrangement is, for example, determined in a self-organized manner, in particular automatically. This means that each optoelectronic component can be assigned, for example, a specific address that is characteristic of the spatial arrangement of the optoelectronic components.

Furthermore, it is possible that an arrangement of a plurality of optoelectronic components is determined using the method disclosed herein. In this case, each optoelectronic component generates a respective optical signal which is specific to a single optoelectronic component. These specific optical signals can then be received by adjacent optoelectronic components, in particular by at least one segment of the adjacent optoelectronic component. Thus, the arrangement of the plurality of optoelectronic components can be determined dependent on the specific optical signals.

The determination of the arrangement is carried out automatically after a new installation of optoelectronic components, for example, so that the arrangement of the optoelectronic components is determined advantageously automatically by the specified method with. Thus, each component can be assigned advantageously the address by which the component can be controlled independently of the other components. A manual addressing of different components is thus advantageously omitted. Furthermore, different lighting scenarios can be implemented particularly easily.

For example, the components can be driven depending on the arrangement. Advantageously, this driving can be carried out in such a way that no spots are created on the floor and a particularly homogeneous illumination is made possible. In this case, not only the addressing, i.e. the determination of the arrangement, but also the tuning of the different components takes place automatically and without adjustment effort.

According to at least one embodiment of the method, the arrangement is determined dependent on a threshold value of the received optical signal. The optical signal illuminates the region during pulses of the sequence, such that the luminance of the region is increased at these times.

If the luminance increases by at least 10% at these times, the threshold value is exceeded. If the luminance does not increase by at least 10% at these times, the threshold value is not reached. If the threshold value is not reached, the optoelectronic component that emits the optical signal is not arranged directly adjacent to the optoelectronic component for which the luminance falls below the threshold value.

According to at least one embodiment of the method, at least two regions of different optoelectronic components overlap in lateral directions.

According to at least one embodiment of the method, the regions of the optoelectronic components are formed without overlapping in lateral directions.

According to at least one embodiment of the method, the optical signal is specific to the optoelectronic component. For example, each optoelectronic component is assigned a specific optical signal, in particular a specific sequence. The specific optical signals of different optoelectronic components differ from one another.

According to at least one embodiment of the method, the optical signal specific to the optoelectronic component is stored in an electronic semiconductor chip. For example, each optoelectronic component comprises an electronic semiconductor chip. On each electronic semiconductor chip, for example, each optical signal specific to a respective optoelectronic component is stored. That is, the electronic semiconductor chip of an optoelectronic component also stores the optical signals that are specific to other optoelectronic components.

According to at least one embodiment of the method, the optoelectronic components do not communicate with each other by means of electrical signals. Since in each case an optical signal is assigned to an individual optoelectronic component and each optoelectronic component comprises an electronic semiconductor chip on which the optical signals are stored, the optoelectronic components can be controlled by means of the electronic semiconductor chips and, without being electrically connected to one another, can determine the arrangement by means of the optical signals.

Such optoelectronic components can be installed advantageously without complex electrical connections for communication.

The method described herein for determining an arrangement of at least two optoelectronic components can be performed in particular before the method for driving at least one segment of the optoelectronic component.

In the following, the optoelectronic component described herein as well as the methods described herein are explained in more detail with reference to exemplary embodiments and the associated Figures.

They show:

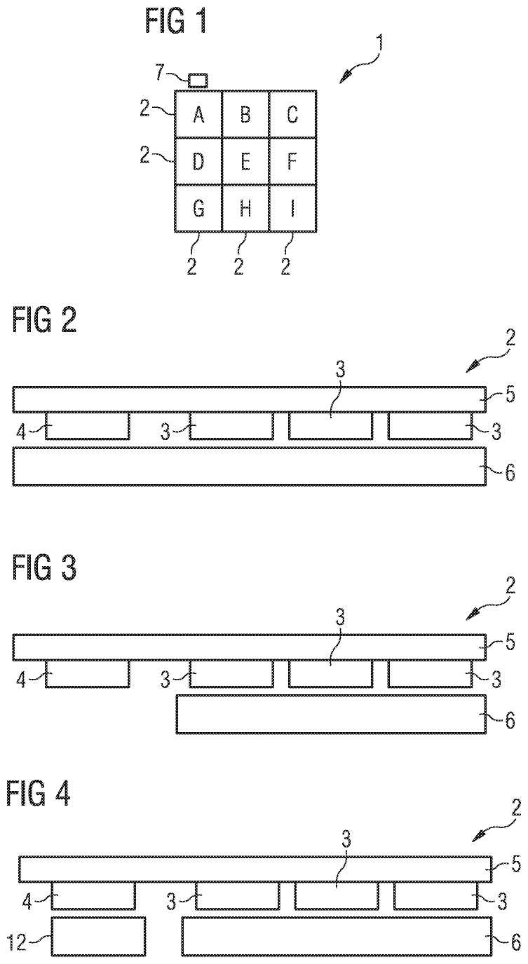

FIG. 1 a schematic representation in plan view of an optoelectronic component according to an exemplary embodiment,

FIGS. 2, 3 and 4 schematic sectional view of a segment of an optoelectronic component according to a respective embodiment,

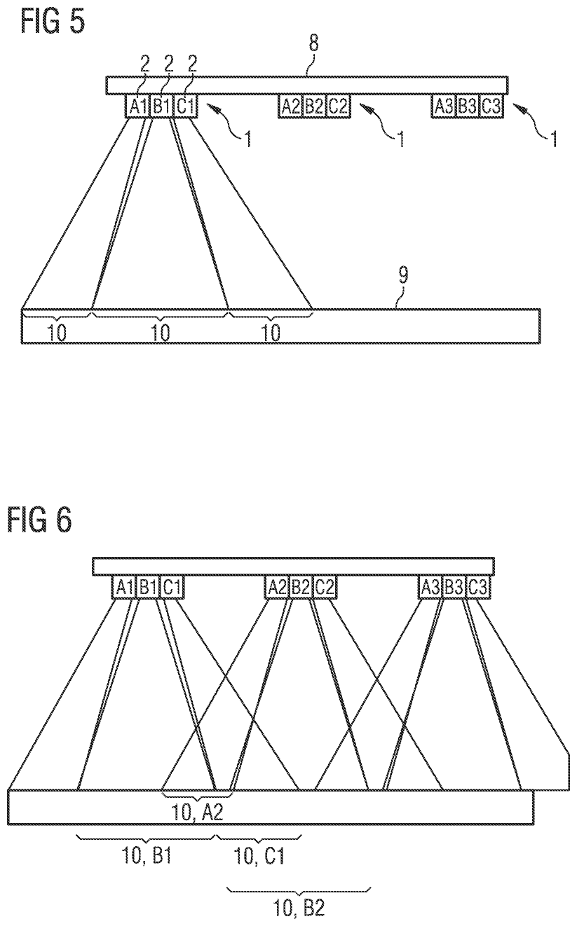

FIG. 5 a schematic sectional view of an arrangement of optoelectronic components according to an embodiment,

FIG. 6 a method for determining an arrangement of at least two optoelectronic components according to an embodiment,

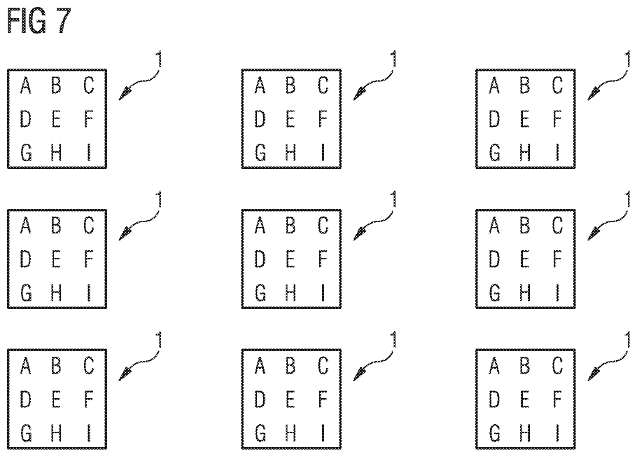

FIG. 7 a schematic representation in plan view of an arrangement of optoelectronic components according to an exemplary embodiment,

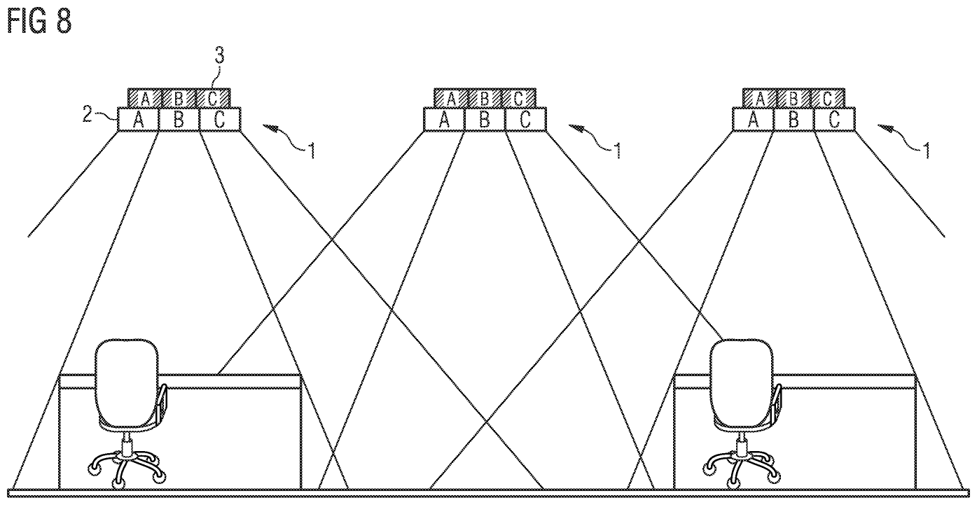

FIG. 8 a schematic sectional view of an arrangement of optoelectronic components according to an embodiment,

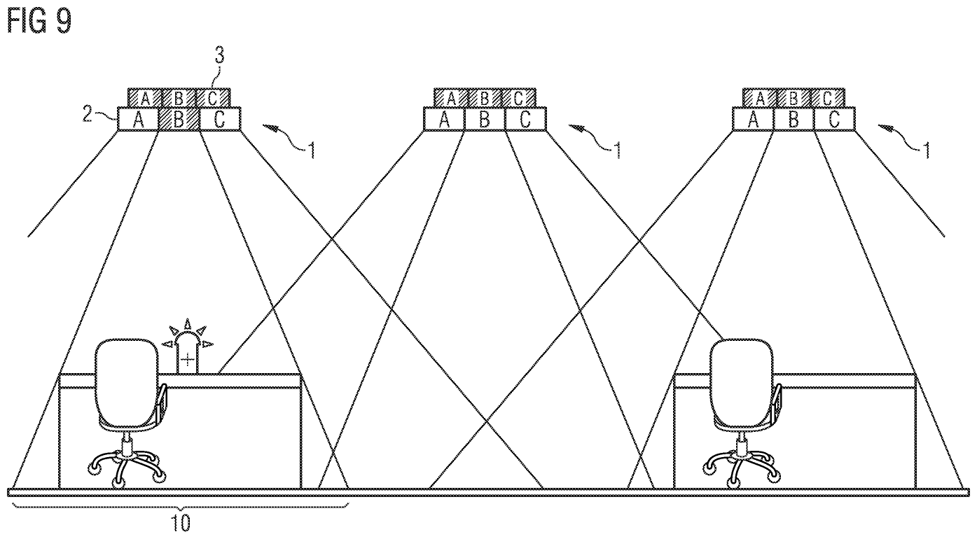

FIGS. 9, 10, and 11, each a method for driving at least one segment of the optoelectronic component according to an embodiment, and

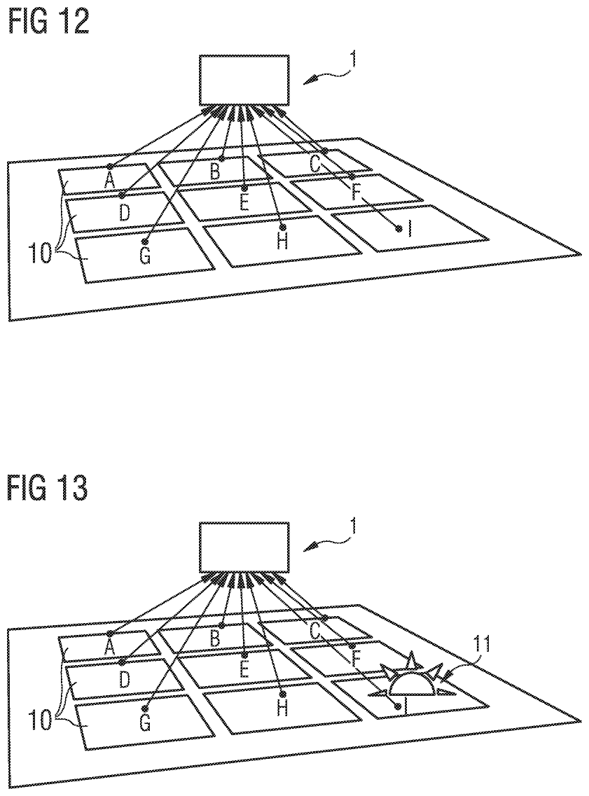

FIGS. 12 and 13 each an optoelectronic component illuminating different regions,

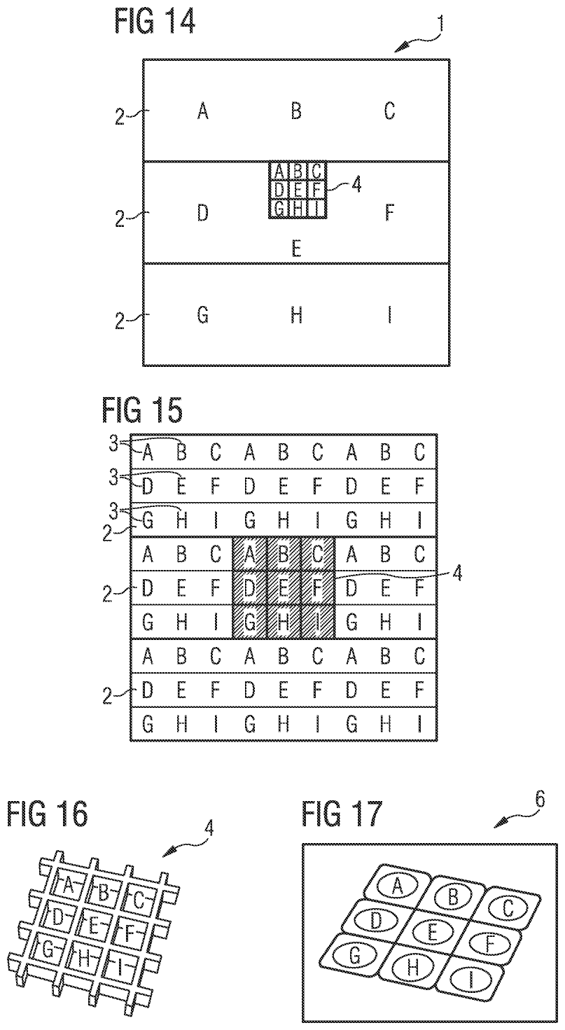

FIGS. 14 and 15 each a schematic representation in plan view of an optoelectronic component according to an exemplary embodiment,

FIG. 16 is a schematic representation of a radiation detecting semiconductor chip, and

FIG. 17 a schematic representation of an optics.

Elements that are identical, similar or have the same effect are given the same reference signs in the Figures. The Figures and the proportions of the elements shown in the Figures are not to be regarded as to scale. Rather, individual elements can be shown exaggeratedly large for better representability and/or for better comprehensibility.

The optoelectronic component 1 according to the exemplary embodiment of FIG. 1 comprises nine segments 2, which are arranged in a matrix-like manner, i.e. along rows and columns, next to each other in lateral directions. In this case, the segments 2 are arranged in a matrix-like manner along three rows and three columns. Each column and each row comprises, for example, three segments 2. Each segment 2 is marked with a letter A to I in FIG. 1.

Further, the optoelectronic component 1 comprises an electronic semiconductor chip 7 electrically conductively connected to each of the segments 2. For example, the electronic semiconductor chip 7 is formed with an integrated circuit.

The segment 2 in FIG. 2 comprises three radiation emitting semiconductor chips 3, which is configured to generate electromagnetic radiation. Furthermore, the segment 2 comprises a radiation detecting semiconductor chip 4 which is configured to detect electromagnetic radiation. The radiation emitting semiconductor chips 3 and the radiation detecting semiconductor chip 4 are arranged on a common carrier 5. The common carrier 5 is formed with a printed circuit board, for example.

In addition, an optics 6 is arranged above the radiation emitting semiconductor chips 3 and the radiation detecting semiconductor chip 4. In this exemplary embodiment, the optics completely overlaps with the radiation emitting semiconductor chips 3 and the radiation detecting semiconductor chip 4 in the lateral direction. In this exemplary embodiment, the optics 6 is a common optics 6 for the radiation emitting semiconductor chips 3 and the radiation detecting semiconductor chip 4.

In contrast to FIG. 2, the optics 6 is arranged on the radiation emitting semiconductor chips 3 according to FIG. 3. No optics 6 is arranged on the radiation detecting semiconductor chip 4.

According to FIG. 4, in contrast to FIG. 3, a further optics 12 is arranged on the radiation detecting semiconductor chip 4 in addition to the optics 6 on the radiation emitting semiconductor chips 3. The further optics 12 on the radiation detecting semiconductor chip 4 is not formed integrally with the optics 6 on the radiation emitting semiconductor chips 3.

The arrangement of FIG. 5 comprises three optoelectronic components 1, each comprising three segments 2. The optoelectronic components 1 are attached to a ceiling 8 of a room at a distance from each other in lateral directions.

The optoelectronic component 1 with the segments 2 A1, B1 and C1 is arranged in a left area of the room. The optoelectronic component 1 with the segments 2 A2, B2 and C2 is arranged in a central area of the room and the optoelectronic component 1 with the segments 2 A3, B3 and C3 is arranged in a right area of the room.

A radiation emitting semiconductor chip 3, in particular all radiation emitting semiconductor chips 3, of a single segment 2 is/are configured to illuminate a single region 10 on a floor 9 of the room. The segment 2 A1 illuminates the region 10, A1, the segment 2 B1 illuminates the region 10, B1 and the segment 2 C1 illuminates the region 10, C1. For example, in the exemplary embodiment of FIG. 5, only the optoelectronic component 1 in the left area is in operation.

For example, lateral dimensions of a region can be predetermined dependent on the optics 6 arranged over the radiation emitting semiconductor chip 3 of the segment 2.

In contrast to the exemplary embodiment of FIG. 5, in the exemplary embodiment of FIG. 6 all optoelectronic components 1 are in operation. Some of the regions 10 illuminated by the segments 2 of directly adjacent optoelectronic components 1 at least partially overlap in lateral directions. Regions 10 illuminated by the segments 2 of the optoelectronic components 1 in the left and right areas are formed without overlapping in lateral directions.

Initially, an optical signal is generated with segments 2 of the optoelectronic component 1 in the left area. The optical signal is generated by the radiation emitting semiconductor chips 3 of the segments 2. Thus, regions 10 of segments 2 A1, B1 and C1 are illuminated with the optical signal. The optical signal is specific to the optoelectronic component 1.

Subsequently, the optical signal emitted from the optoelectronic component 1 in the left area can be received by segments 2 of the optoelectronic component 1 in the central area. The segments 2 A2, B2, and C2 each comprise a radiation detecting semiconductor chip 4, each of which is configured to detect electromagnetic radiation in regions 10 associated with segments 2 A2, B2, and C2. The radiation emitting semiconductor chip 3 of the segment 2 A2 is configured to illuminate the region 10, A2 and the radiation detecting semiconductor chip 4 of the segment 2 A2 is configured to detect electromagnetic radiation in the region 10, A2. That is, the radiation emitting semiconductor chip 3 and the radiation detecting semiconductor chip 4 of the same segment 2 are directed to the same region 10.

The regions 10, B1 and 10, C1 of the optoelectronic component 1 of the left area overlap with the region 10, A2 of the optoelectronic component 1 of the central area. Furthermore, the regions 10, C1 and 10, B2 overlap with each other. Thus, the radiation detecting semiconductor chips 4 of the optoelectronic component 1 of the central area of the segments 2 A2 and B2 receive the optical signal of the optoelectronic semiconductor chip of the optoelectronic component 1 of the left area.

In the following, an arrangement of the optoelectronic component 1 of the left area and the optoelectronic component 1 of the central area is determined depending on the received optical signal.

The optoelectronic component 1 of the central area further comprises an electronic semiconductor chip 7 on which the optical signal of the optoelectronic semiconductor chip of the left area is stored.

When determining, the received optical signal is compared with the stored optical signals, for example, by a comparison rule. The comparison then determines that the specific optical signal is assigned to the optoelectronic component 1 of the left area and that the optoelectronic component 1 of the left area is arranged to the left of the optoelectronic component 1 of the central area.

Subsequently, all optoelectronic components 1 can emit a specific optoelectronic signal. Thus, a complete spatial arrangement of the optoelectronic components 1 is determined.

The arrangement of FIG. 7 comprises nine optoelectronic components 1 arranged in a matrix-like manner, i.e. along rows and columns. Each column and each row comprises, for example, three optoelectronic components 1. The components 1 are spaced apart in lateral directions.

Like the arrangement in FIG. 5, the arrangement in FIG. 8 comprises three optoelectronic components 1, each of which comprises three segments 2. A work area comprising a table and a chair is arranged under the optoelectronic component 1 in the right area and under the optoelectronic component 1 in the left area. The segment 2 B of the optoelectronic component 1 in the right area is configured to illuminate the region 10 of the work area in the right area.

In the method for driving at least one segment 2 of the optoelectronic component 1 according to FIG. 9, an optical signal is initially generated in the region 10 using a mobile device 11. The mobile device 11 is, for example, a mobile phone comprising a flash light. The flash light emits the optical signal in the form of electromagnetic radiation.

In this exemplary embodiment, the mobile device 11 is positioned on the table of the work area. That is, the mobile device 11 is positioned in the region 10 that illuminates the segment 2 A of the optoelectronic component 1 in the left area. The optical signal of the mobile device 11 is received by the radiation detecting semiconductor chip 4 of the segment 2 A of the optoelectronic component 1 in the left area associated with the region 10.

Subsequently, the radiation emitting semiconductor chip 3 drives the segment 2 A of the optoelectronic component 1 in the left area, depending on the optical signal of the mobile device 11. The operating current of the radiation emitting semiconductor chip 3 is decreased or increased depending on the optical signal.

In this embodiment, the optical signal is formed such that an illumination and thus an operating current of the radiation emitting semiconductor chip 3 of the segment 2 A of the optoelectronic component 1 are increased in the left area.

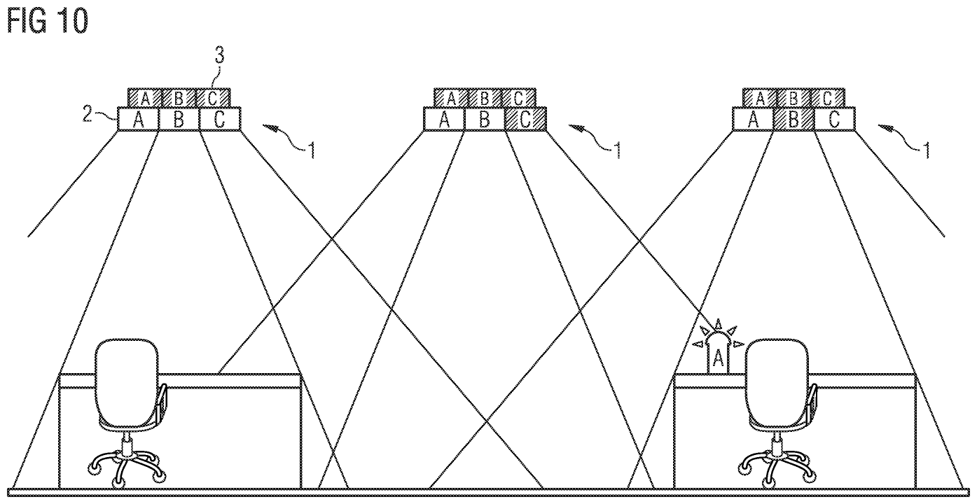

In contrast to FIG. 8, the mobile device 11 is positioned on the table in the right area according to FIG. 10. The optical signal is received by the radiation emitting semiconductor chips 3 of segment 2 C of optoelectronic component 1 in the central area and segment 2 B of optoelectronic component 1 in the right area.

In this embodiment, the optical signal is formed such that an illumination and thus an operating current of the radiation emitting semiconductor chip 3 of the segment 2 C of the optoelectronic component 1 in the central area and the segment 2 B of the optoelectronic component 1 in the right region are increased.

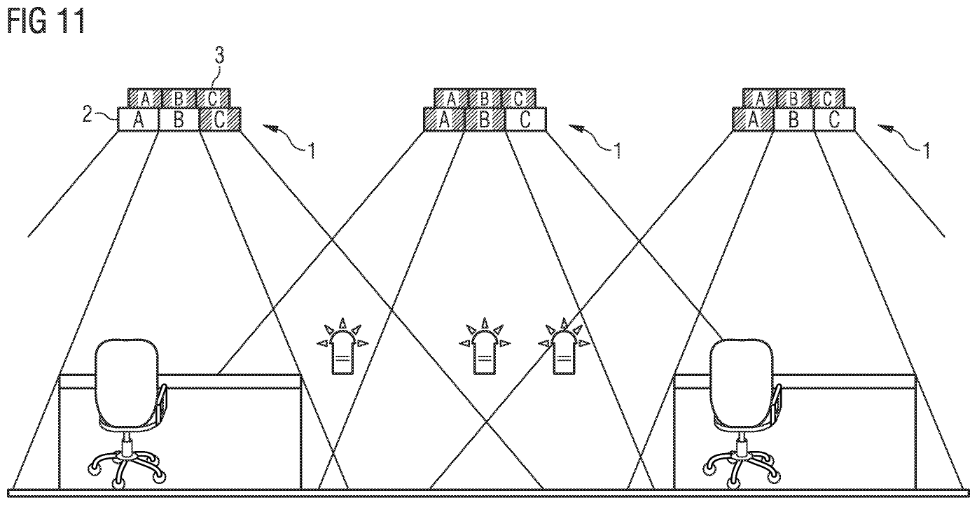

The mobile device 11 is positioned in the FIG. 11, in contrast to the FIGS. 9 and 10 between the tables in the central area. In this exemplary embodiment, the optical signal is such that an illumination and thus an operating current of the radiation emitting semiconductor chip 3 of the segment 2 C of the optoelectronic component 1 in the right area and the segments 2 A and B of the optoelectronic component 1 in the central area are reduced.

The optoelectronic component 1 according to FIG. 12 comprises 9 segments 2 as shown in FIG. 1, each segment 2 is assigned to a region 10. That is, each segment 2 A to I is configured to illuminate a region 10 associated with the segment 2. In this exemplary embodiment, the regions 10 do not overlap in lateral directions. Accordingly, the optoelectronic component 1 is configured to illuminate nine regions 10.

According to the exemplary embodiment of FIG. 13, a mobile device 11 is arranged in the illuminated region 10, which is associated with a sequence I. An optical signal emitted by the mobile device 11 is received by a radiation detecting semiconductor chip 4 associated with the sequence I, as explained in more detail in connection with FIGS. 9 to 11.

The optoelectronic component 1 according to the exemplary embodiment of FIG. 14 comprises nine segments 2 A to I, as explained in more detail in FIG. 1. In this exemplary embodiment, nine radiation emitting semiconductor chips 3 A to I are arranged in the central segment 2 E. Each radiation emitting semiconductor chip 3 is assigned a corresponding segment 2 A to I.

According to the exemplary embodiment of FIG. 15, each segment 2 A to I, as shown in FIG. 1, comprises nine radiation emitting semiconductor chips 3 A to I, which are arranged at grid points of a second regular grid. In this case, the radiation emitting semiconductor chips 3 A to I are arranged in a matrix-like manner, that is, along rows and columns. Three radiation emitting semiconductor chips 3 are arranged along each row and along each row. In this exemplary embodiment, each individual radiation emitting semiconductor chip 3 of a segment 2 is independently drivable. That is, each of the individual radiation emitting semiconductor chips 3 forms a sub-segment of a segment 2.

As explained in more detail in FIG. 14, nine radiation emitting semiconductor chips 3 are arranged in the central segment 2.

The radiation emitting semiconductor chips 3 shown in FIG. 14 or 15 are a field sensor module, as shown in FIG. 16. Here, the module comprises nine fields, each formed with a radiation detecting semiconductor chip 3. Each radiation detecting semiconductor chip 3 further comprises an optical shutter.

The optics 6 according to FIG. 17 comprises nine sub-areas A to I, each sub-area being assigned to a segment 2. The optics 6 here is a common optics 6 for all segments 2 of an optoelectronic component 1.

This patent application claims the priority of German patent application 10 2020 131 346.2, the disclosure content of which is hereby incorporated by reference.

The features and exemplary embodiments described in connection with the Figures can be combined with each other according to further exemplary embodiments, even if not all combinations are explicitly described. Furthermore, the exemplary embodiments described in connection with the Figures can alternatively or additionally have further features according to the description in the general part.

The invention is not limited to these by the description based on the exemplary embodiments. Rather, the invention encompasses any new feature as well as any combination of features, which in particular includes any combination of features in the patent claims, even if this feature or combination itself is not explicitly stated in the patent claims or exemplary embodiments.

### LIST OF REFERENCE SIGNS

1 optoelectronic component
2 segment
3 radiation emitting semiconductor chip
4 radiation detecting semiconductor chip
5 carrier
6 optics
7 electronic semiconductor chip
8 ceiling
9 floor
10 region
11 mobile device
12 further optics

1. Optoelectronic component, with
at least one segment, wherein
each segment comprises two or more radiation emitting semiconductor chips configured to emit electromagnetic radiation into a region,
each segment is associated with a radiation detecting semiconductor chip configured to detect electromagnetic radiation from the region, and
each individual radiation emitting semiconductor chip of a segment is drivable independently of the other radiation emitting semiconductor chips of the segment.

2. Optoelectronic component according to claim 1, in which at least one segment comprises a common carrier on which the radiation emitting semiconductor chips and the radiation detecting semiconductor chip are arranged.

3. Optoelectronic component according to claim 1, in which at least one segment
comprises an optics, and
the optics is arranged on the radiation emitting semiconductor chips and the radiation detecting semiconductor chip of a segment, or
the optics is arranged on the radiation emitting semiconductor chips of a segment.

4. Optoelectronic component according to claim 1, in which
at least one segment comprises at least two optics,
one of the two optics is arranged on the radiation detecting semiconductor chip of a segment, and
the other of the two optics is arranged on the radiation emitting semiconductor chips of a segment.

5. Optoelectronic component according to claim 1, having an electronic semiconductor chip which is electrically conductively connected to at least one segment.

6. Method for driving at least one segment of the optoelectronic component according to claim 1 with at least two segments, comprising the steps:
generating an optical signal in the region with a mobile device,
receiving the optical signal of the mobile device by the radiation detecting semiconductor chip associated with the region
driving one of the segments associated with the radiation detecting semiconductor chip dependent on the optical signal of the mobile device.

7. Method according to claim 6, wherein at least two regions are formed without overlapping in lateral directions.

8. Method according to claim 6, wherein
the optoelectronic component comprises at least three segments, and
at least two of the regions are formed overlapping in lateral directions.

9. Method according to claim 6, wherein the segment is driven dependent on the optical signal of the mobile device such that a luminance in the region is increased or that a luminance in the region is decreased.

10. Method according to claim 6, wherein
at least two segments of different optoelectronic components have two regions which overlap in lateral directions, and
the segments of the different optoelectronic components are driven dependent on the optical signal.

11. Method for determining an arrangement of at least two optoelectronic components according to claim 1, comprising the steps:
generating an optical signal with segments from at least one of the optoelectronic components,
receiving the optical signal from one of the segments of another optoelectronic component,
determining an arrangement of the at least two optoelectronic components dependent on the received optical signal.

12. Method according to claim 11, wherein the arrangement is determined dependent on a threshold value of the received optical signal.

13. Method according to claim 12, wherein
at least two regions of different optoelectronic components overlap in lateral directions, and/or
the regions of the optoelectronic components are formed without overlapping in lateral directions.

14. Method according to claim 10, wherein the optical signal is specifically predetermined for the optoelectronic component.

15. Method according to claim 14, wherein the optical signal specific to the optoelectronic component is stored in an electronic semiconductor chip.

16. Method according to claim 10, wherein the optoelectronic components do not communicate with each other by electrical signals.
